(19) United States
(12) Patent Application Publication
(10) Pub. No.: US 2024/0299904 A1
(43) Pub. Date: Sep. 12, 2024

(54) WATER PURIFICATION FILTER AND WATER PURIFIER

(71) Applicant: KURARAY CO., LTD., Kurashiki-shi, Okayama (JP)

(72) Inventors: Kengo SUZUKI, Okayama (JP); Shuji KAWASAKI, Okayama (JP); Satoru ARITA, Okayama (JP); Tetsuya HANAMOTO, Okayama (JP); Hiroe YOSHINOBU, Okayama (JP)

(73) Assignee: KURARAY CO., LTD., Kurashiki-shi, Okayama (JP)

(21) Appl. No.: 18/291,804

(22) PCT Filed: Jul. 26, 2022
(86) PCT No.: PCT/JP2022/028806

§ 371 Date: Jan. 24, 2024

(30) Foreign Application Priority Data
Jul. 30, 2021 (JP) 2021-125623

(51) Int. Cl. B01J 20/20; B01J 20/28; C02F 1/28; C02F 101/36

(52) U.S. Cl. CPC B01J 20/20; B01J 20/28004; B01J 20/28016; B01J 20/2803; B01J 20/28042; B01J 20/28064; B01J 20/28066; B01J 20/28071; B01J 20/28073; B01J 20/28076; C02F 1/283; C02F 2101/36

(57) ABSTRACT

A water purification filter according to the present invention contains activated carbon and one or more fibrous binders, in which the fibrous binder has a maximum fiber length of 3.0 mm or more and has one or more physical properties (a) to (c) shown below: (a) having an average shape of 80% or less; (b) having an average fiber width of 20 μm or less; and (c) in a fiber length distribution, having a ratio of a frequency of fibers having a length of 0.2 mm to 0.5 mm to a frequency of fibers having a length of 1.0 mm to 2.0 mm of 1.0 or more.

### TECHNICAL FIELD

The present invention relates to a water purification filter comprising activated carbon and a fibrous binder, and a water purifier comprising the water purification filter.

### BACKGROUND ART

From the viewpoint of safety and health related to the water quality of tap water, it is desired to remove various substances contained in tap water, such as volatile organic compounds (VOCs) including chloroform and trihalomethane, turbid substances, and substances causing mold odor such as 2-methylisoborneol (hereinafter, also simply referred to as “2-MIB”). To remove these substances, typically used is a water purification filter formed of a molded body containing activated carbon and a fibrous binder.

For example, Patent Literature 1 describes a molded adsorbent containing: an adsorbent containing activated carbon; and a fibrous binder. It is described that in the molded adsorbent, by adjusting the particle size of the activated carbon, voids are appropriately formed between the activated carbon particles when the molded adsorbent is molded, and finally a molded adsorbent having excellent adsorption performance and a small water flow pressure loss can be obtained.

Further, for example, Patent Literature 2 describes a molded adsorbent obtained by molding a filter material containing activated carbon as a main component using a fibrous binder. It is described that in the molded adsorbent, the molding strength can be increased and the filtration resistance can be lowered while the adsorption capacity of the molded adsorbent is enhanced by using activated carbon having an adjusted particle size and a fibrous binder having a filtration degree of water adjusted to be low to a specific range by fibrillation.

### CITATION LIST

### Patent Literatures

Patent Literature 1: JP 2015-112518 A
Patent Literature 2: JP 2011-255310 A

### SUMMARY OF INVENTION

An object of the present invention is to provide a water purification filter having excellent adsorption performance.

As a result of intensive studies to solve the above problems, the inventors of the present invention have reached the present invention. That is, the present invention includes the following preferred aspects.

A water purification filter according to a first aspect of the present invention comprises activated carbon and one or more fibrous binders, wherein the fibrous binder has a maximum fiber length of 3.0 mm or more and has one or more physical properties (a) to (c) shown below:
(a) having an average shape of 80% or less;
(b) having an average fiber width of 20 μm or less; and
(c) in a fiber length distribution, having a ratio of a frequency of fibers having a length of 0.2 mm to 0.5 mm to a frequency of fibers having a length of 1.0 mm to 2.0 mm of 1.0 or more.

Alternatively, a water purification filter according to another first aspect of the present invention comprises activated carbon and one or more fibrous binders, wherein a lightness L* of a surface of an activated carbon layer of the water purification filter is 29 or more.

A water purifier according to a second aspect of the present invention comprises the water purification filter according to the first aspect of the present invention.

### BRIEF DESCRIPTION OF DRAWINGS

FIG. 1 is a perspective view illustrating an example of a framework for preparing a water purification filter according to first and second embodiments.

FIG. 2 is a perspective view illustrating an example of a water purification filter in the first and second embodiments obtained using the framework of FIG. 1.

FIG. 3 is a schematic view for describing a method for calculating a shape (%) of a fiber of a fibrous binder.

### DESCRIPTION OF EMBODIMENTS

In recent years, a water purification filter having excellent adsorptivity with a small size has been required as a water purification filter especially for home use. However, in a downsized water purification filter, the frequency of contact with activated carbon as an adsorbent is inevitably reduced, and thus it is difficult to exhibit excellent adsorptivity as compared with a conventional water purification filter having a typical size.

As described in Patent Literature 1 or Patent Literature 2, the adsorption performance of a water purification filter can be enhanced by adjusting the particle size of activated carbon. However, further improvement of the adsorption performance of the water purification filter is limited only by means of adjusting the physical properties of activated carbon serving as an adsorbent. Thus, it is required to develop a novel water purification filter capable of realizing high adsorptivity from the viewpoint other than the change of the adsorbent and/or the adjustment of the physical properties such as the particle size of the adsorbent.

As a result of intensive studies by the inventors of the present invention, it has been found that when a fibrous binder comprised in a water purification filter has predetermined physical properties, the water purification filter is densified, and the adsorption performance of the water purification filter can be improved. In addition, it has been found that the water purification filter densified by comprising the fibrous binder having predetermined physical properties as described above has a high value of the lightness L* of the surface of the activated carbon layer of the water purification filter.

Hereinafter, embodiments of the present invention will be described in detail. The scope of the present invention is not limited to the embodiments described herein, and various modifications can be made without impairing the gist of the present invention.

### 1. Water Purification Filter

### 1-1. First Embodiment

A water purification filter according to a first embodiment comprises activated carbon and one or more fibrous binders,
wherein the fibrous binder has a maximum fiber length of 3.0 mm or more and has one or more physical properties (a) to (c) shown below:
(a) having an average shape of 80% or less;
(b) having an average fiber width of 20 μm or less; and
(c) in a fiber length distribution, having a ratio of a frequency of fibers having a length of 0.2 mm to 0.5 mm to a frequency of fibers having a length of 1.0 mm to 2.0 mm of 1.0 or more.

The water purification filter having such a configuration has excellent adsorption performance. Specifically, having the above-described configuration can densify the water purification filter and also can improve frequency of contact between water and activated carbon serving as an adsorbent. As a result, finally, the adsorption performance of the water purification filter can be improved.

### [Configuration of Water Purification Filter]

The water purification filter according to the first embodiment comprises activated carbon and one or more fibrous binders. Hereinafter, these components will be described in detail.

### (Fibrous Binder)

The fibrous binder comprised in the water purification filter has a maximum fiber length of 3.0 mm or more. With the water purification filter comprising a fibrous binder having a maximum fiber length of 3.0 mm or more, a frame of a strong molded body is formed, and high filter strength can be realized. The maximum fiber length is preferably 3.5 mm or more, more preferably 4.0 mm or more, and particularly preferably 4.5 mm or more. The upper limit of the maximum fiber length is not particularly limited as long as it does not affect the formation of the molded body of the water purification filter, but is preferably, for example, 8 mm or less.

Further, the fibrous binder having a maximum fiber length of 3.0 mm or more has one or more physical properties (a) to (c) shown below:
(a) having an average shape of 80% or less;
(b) having an average fiber width of 20 μm or less; and
(c) in a fiber length distribution, having a ratio of a frequency of fibers having a length of 0.2 mm to 0.5 mm to a frequency of fibers having a length of 1.0 mm to 2.0 mm of 1.0 or more.

In the present specification, the terms “average shape”, “average fiber width”, “fiber length distribution”, and “average fibril area” relating to the physical properties of the fibrous binder mean “length-weighted average shape”, “length-weighted average fiber width”, “length-weighted fiber length distribution”, and “length-weighted average fibril area”, respectively. Further, in the present specification, these numerical values and “maximum fiber length” are values calculated by performing image analysis of 20,000 fibers having a fiber length of 200 μm or more with a fiber physical property measuring apparatus (“L&W FIBER TESTER PLUS+”, manufactured by ABB Ltd.) and using Formulas (1) to (4) described later, as described later in detail in Examples.

In the present specification, when the water purification filter comprises two or more fibrous binders, the numerical values of “maximum fiber length”, “average shape”, “average fiber width”, “fiber length distribution”, and “average fibril area” are values calculated by image analysis of fibers using a mixture of two or more fibrous binders as described later in detail in Examples.

When the water purification filter comprises a fibrous binder having a maximum fiber length of 3.0 mm or more and having one or more of the physical properties (a) to (c), the water purification filter can be densified, and the adsorption performance of the water purification filter can be improved. Hereinafter, the respective physical properties of (a) to (c) in the fibrous binder will be described in detail.

### (a) Having an Average Shape of 80% or Less

The average shape of the fibrous binder means, in other words, the degree of linearity of the fibers of the fibrous binder when the fibrous binder is dispersed in water. That is, the linearity of the fibers decreases as the average shape value changes from 100% to a smaller value. When the average shape is 80% or less, the linearity of the fibers of the fibrous binder when the fibrous binder is dispersed in water is low, the shape of the fibers is easily deformed at the time of molding of the water purification filter, and the activated carbon and the fibers are easily entangled between the fibers. As a result, the water purification filter can be densified, leading to improvement of the adsorption performance of the water purification filter.

The average shape of the fibrous binder is preferably 79% or less, and more preferably 78% or less. As the average shape of the fibrous binder is smaller, the shape of the fibers is more easily deformed, the activated carbon and the fibers are more easily entangled between the fibers, and the water purification filter can be more densified.

The lower limit of the average shape of the fibrous binder is not particularly limited, but for example, the average shape is preferably 70% or more. With the average shape of the fibrous binder being 70% or more, good water permeability of the water purification filter can be secured.

### (b) Having an Average Fiber Width of 20 μm or Less

The fiber strength is weakened with the fibrous binder having an average fiber width of 20 μm or less. Thus, the shape of the fibers is easily deformed at the time of molding the water purification filter, and the activated carbon and the fibers are easily entangled between the fibers. As a result, the water purification filter can be densified, leading to improvement of the adsorption performance of the water purification filter.

The average fiber width of the fibrous binder is preferably 19.5 μm or less, more preferably 18.5 μm or less, and still more preferably 18 μm or less. As the average fiber width of the fibrous binder is smaller, the shape of the fibers is more easily deformed, the activated carbon and the fibers are more easily entangled between the fibers, and the water purification filter can be more densified. The lower limit of the average fiber width of the fibrous binder is not particularly limited, but for example, the average fiber width is 16 μm or more.

### (c) In a Fiber Length Distribution, Having a Ratio of a Frequency of Fibers Having a Length of 0.2 mm to 0.5 mm to a Frequency of Fibers Having a Length of 1.0 mm to 2.0 mm of 1.0 or More

When the ratio (hereinafter, also referred to as “fiber length ratio (0.2 mm to 0.5 mm)/(1.0 mm to 2.0 mm)”) of the frequency of fibers having a length of 0.2 mm to 0.5 mm to the frequency of fibers having a length of 1.0 mm to 2.0 mm in the fibrous binder is 1.0 or more, the fiber lengths of the binder are uneven, and there are more short fibers. Thus, filling properties improve at the time of molding the water purification filter. As a result, the water purification filter can be densified, leading to improvement of the adsorption performance of the water purification filter.

The fiber length ratio (0.2 mm to 0.5 mm)/(1.0 mm to 2.0 mm) is preferably 1.5 or more, more preferably 2.0 or more. It may be 30 or more. As the fiber length ratio (0.2 mm to 0.5 mm)/(1.0 mm to 2.0 mm) is larger, the water purification filter can be further densified, and the adsorption performance of the water purification filter can be further improved. The upper limit of the fiber length ratio (0.2 mm to 0.5 mm)/(1.0 mm to 2.0 mm) is not particularly limited, but for example, the fiber length ratio (0.2 mm to 0.5 mm)/(1.0 mm to 2.0 mm) may be 70 or less or 50 or less.

In addition, it is further preferable that the fibrous binder having a maximum fiber length of 3.0 mm or more and having one or more of the physical properties (a) to (c) has the following physical property (d).

### (d) Having an Average Fibril Area of 11% or More

The average fibril area of the fibrous binder having a maximum fiber length of 3.0 mm or more and having one or more of the properties (a) to (c) is preferably 11% or more. In other words, the average fibril area of the fibrous binder means the proportion of the area of the fibrillated fiber portion with respect to the entire fiber area of the fibrous binder. With the average fibril area of the fibrous binder being 11% or more, not only the adsorption performance of the water purification filter can be further improved, but also the strength of the water purification filter can be improved.

The average fibril area of the fibrous binder is more preferably 11.5% or more, still more preferably 12% or more, and particularly preferably 14% or more. As the average fibril area of the fibrous binder is larger, the adsorption performance and strength of the water purification filter can be further improved. The average fibril area of the fibrous binder is not particularly limited, and is, for example, preferably 20% or less. By setting the average fibril area of the fibrous binder to 20% or less, excessive processing due to fibrillation of the fibrous binder can be suppressed, and productivity can be increased.

The type of the fibrous binder having a maximum fiber length of 3.0 mm or more and having one or more of the physical properties (a) to (c) is not particularly limited as long as the fibrous binder satisfies the physical property conditions and can be molded with activated carbon being entangled. Examples of such a fibrous binder include an acrylic fibrous binder, a cellulose fibrous binder, an aramid fibrous binder, and an olefin fibrous binder. These fibrous binders may be contained alone or in combination of two or more thereof. Of these, the fibrous binder preferably contains an acrylic fibrous binder.

The fibrous binder having a maximum fiber length of 3.0 mm or more and having one or more of the physical properties (a) to (c) preferably has all the physical properties (a) to (c). With the water purification filter comprising the fibrous binder having all the physical properties (a) to (c), the water purification filter can be further densified, and the adsorption performance of the water purification filter can be reliably enhanced. Examples of the fibrous binder having a maximum fiber length of 3.0 mm or more and having all of the physical properties (a) to (c) include “CFF111” (manufactured by Sterling Fibers Inc.), which is a commercially available acrylic fibrous binder.

Further, the fibrous binder having a maximum fiber length of 3.0 mm or more and having one or more of the physical properties (a) to (c) preferably has all the physical properties (a) to (d). With the water purification filter comprising a fibrous binder having a maximum fiber length of 3.0 mm or more and having all the physical properties (a) to (d), the water purification filter can be further densified. As a result, not only the adsorption performance of the water purification filter can be remarkably enhanced, but also the strength of the water purification filter can be enhanced. The fibrous binder having a maximum fiber length of 3.0 mm or more and having all the physical properties (a) to (d) can be obtained, for example, by refining a fibrous binder (for example, commercially available “CFF111” (manufactured by Sterling Fibers Inc.)) having a maximum fiber length of 3.0 mm or more and having all the physical properties (a) to (c) with a refiner or the like while adjusting the fibrous binder to an appropriate fiber length to fibrillate the fibrous binder.

The water permeability of the fibrous binder is preferably about 10 mL or more and 250 mL or less in terms of CSF value. In the present specification, the CSF value is a value measured with reference to the “Pulps-Determination of drainability-” Canadian Standard Freeness Method defined in JIS P 8121: 2012. Specifically, it is a value evaluated by using tap water having a conductivity of about 100 μs/cm in measurement. The CSF value can be adjusted, for example, by fibrillating the fibrous binder.

By setting the CSF value of the fibrous binder to 10 mL or more, a decrease in the strength of the water purification filter can be suppressed, and the waterflow resistance can be reduced. Further, by setting the CSF value to 250 mL or less, the trapping power of activated carbon increases, the adsorption performance of the water purification filter can be improved, and at the same time, a decrease in the strength of the water purification filter can be suppressed. When two or more fibrous binders are used in combination, the CSF value in a state where two or more fibrous binders are mixed preferably satisfies the above range.

The CSF value of the fibrous binder is more preferably 15 mL or more, still more preferably 17 mL or more, and particularly preferably 20 mL or more. The CSF value of the fibrous binder is more preferably 150 mL or less, still more preferably 50 mL or less, and particularly preferably 40 mL or less.

The blending ratio of the fibrous binder and the activated carbon is not particularly limited as long as they can exhibit their functions when molded as a water purification filter. For example, from the viewpoint of adsorption performance of activated carbon and moldability as a water purification filter, the amount of the fibrous binder (or the total amount of two or more fibrous binders) is preferably 2 parts by mass to 20 parts by mass with respect to 100 parts by mass of activated carbon or 100 parts by mass of the total of activated carbon and a functional component (for example, a lead adsorbent). By setting the amount of the fibrous binder to 2 parts by mass or more, a molded body of a water purification filter having sufficient strength can be obtained. By setting the amount of the fibrous binder to 20 parts by mass or less, a water purification filter having good adsorption performance of a sufficient amount of activated carbon can be obtained.

The mixing ratio of the fibrous binder (or the total amount of two or more fibrous binders) to 100 parts by mass of activated carbon or 100 parts by mass of the total of activated carbon and a functional component (for example, a lead adsorbent) is more preferably 3 parts by mass or more, and still more preferably 4 parts by mass or more. The mixing ratio of the fibrous binder (or the total amount of two or more fibrous binders) to 100 parts by mass of activated carbon or 100 parts by mass of the total of activated carbon and a functional component (for example, a lead adsorbent) is more preferably 10 parts by mass or less, and still more preferably 8 parts by mass or less.

### (Activated Carbon)

The activated carbon to be comprised in the water purification filter is not particularly limited, and it may be used alone or in combination of two or more activated carbons having different physical properties.

The shape of the activated carbon may be any shape of powdered activated carbon, particulate activated carbon, fibrous activated carbon (thread-like, woven cloth-like, felt-like), and the like, and the shape can be appropriately selected according to the application. Alternatively, two or more activated carbons having different shapes may be used in combination. Of these shapes, powdered activated carbon is preferable from the viewpoint of being inexpensive and having high adsorption performance.

The 50% particle size (hereinafter, also simply referred to as “D50) in the volume-based cumulative particle size distribution of the activated carbon measured by a laser diffraction/scattering method is preferably 13 μm or more. By setting the D50 of the activated carbon to 13 μm or more, the moldability of the water purification filter is improved, and it is possible to prevent the waterflow resistance from becoming excessively large. The D50 of the activated carbon is more preferably 16.5 μm or more, and still more preferably 35 μm or more.

D50 measured by a laser diffraction/scattering method of the activated carbon is preferably 500 μm or less. By setting the D50 of the activated carbon to 500 μm or less, the filling rate of the activated carbon in the water purification filter can be improved, and the adsorption performance of the water purification filter can be further improved. The D50 of the activated carbon is more preferably 210 μm or less, and still more preferably 130 μm or less. In the present specification, D50 measured by a laser diffraction/scattering method of activated carbon is more specifically a value measured by a method described later in Examples.

The specific surface area of the activated carbon determined by a nitrogen adsorption method is preferably 800 m²/g or more. By setting the specific surface area of the activated carbon to 800 m²/g or more, the performance of removing volatile organic compounds, CAT, 2-MIB, and the like in the water purification filter can be improved. That is, increasing the adsorbable area can further improve the adsorption performance of the water purification filter. The adsorption performance with respect to volatile organic compounds, CAT, 2-MIB, and the like in the water purification filter is affected by pore size distribution of activated carbon. The pore size distribution and the specific surface area have a correlation, and when the specific surface area of activated carbon is 800 m²/g or more, the activated carbon has a pore size distribution suitable for adsorption. Thus, performance of removing volatile organic compounds, CAT, 2-MIB, and the like can be improved. The specific surface area of the activated carbon is more preferably 900 m²/g or more.

The specific surface area of the activated carbon determined by a nitrogen adsorption method is preferably 2200 m²/g or less. Setting the specific surface area of the activated carbon to 2200 m²/g or less can avoid an extreme increase in the production cost of the activated carbon due to an excessive improvement in the performance of removing volatile organic compounds. In addition, the adsorption performance with respect to volatile organic compounds, CAT, 2-MIB, and the like, in particular, chloroform, in the water purification filter is affected by the pore size distribution, and when the specific surface area correlated with the pore size distribution is too large, the adsorption performance decreases. By setting the specific surface area of the activated carbon to 2200 m²/g or less, the activated carbon has a pore size distribution suitable for adsorption, and thus, performance of removing volatile organic compounds, CAT, 2-MIB and the like, in particular, chloroform, can be improved. The specific surface area of the activated carbon is more preferably 1800 m²/g or less, still more preferably 1500 m²/g or less, and particularly preferably 1300 m²/g or less. In the present specification, the specific surface area (m²/g) of the activated carbon determined by a nitrogen adsorption method is more specifically a value measured by a method described later in Examples.

The total pore volume of the activated carbon determined by a nitrogen adsorption method is preferably 0.350 cm³/g or more. By setting the total pore volume of the activated carbon to 0.350 cm³/g or more, the total adsorbable pore volume is increased, and the adsorption performance of the water purification filter can be further improved. There is a correlation between the pore size distribution and the total pore volume. When the total pore volume of the activated carbon is 0.350 cm³/g or more, the activated carbon has a pore size distribution suitable for adsorption, and thus performance of removing volatile organic compounds, CAT, 2-MIB, and the like can improve. The total pore volume of the activated carbon is more preferably 0.400 cm³/g or more.

The total pore volume of the activated carbon determined by a nitrogen adsorption method is preferably 1.600 cm³/g or less. By setting the total pore volume of the activated carbon to 1.600 cm³/g or less, it is possible to prevent the total pore volume from excessively increasing to change the structure of the activated carbon and affect the adsorption function of the activated carbon. Further, it is possible to avoid the production cost of the activated carbon from extremely increasing. In addition, the adsorption performance with respect to volatile organic compounds, CAT, 2-MIB, and the like, in particular, chloroform, in the water purification filter is affected by the pore size distribution, and when the total pore volume correlated with the pore size distribution is too large, the adsorption performance decreases. By setting the total pore volume of the activated carbon to 1.600 m³/g or less, the activated carbon has a pore size distribution suitable for adsorption, and thus, performance of removing volatile organic compounds, CAT, 2-MIB and the like, in particular, chloroform, can be improved. The total pore volume of the activated carbon is more preferably 0.800 cm²/g or less. In the present specification, the total pore volume (cm²/g) determined by a nitrogen adsorption method of activated carbon is more specifically a value measured by a method described later in detail in Examples.

In the present specification, the values of the D50, specific surface area, and total pore volume of the activated carbon can be controlled, for example, by appropriately selecting and appropriately adjusting the type of the carbonaceous material to be a raw material of the activated carbon, which is described later, the activation treatment method of the carbonaceous material in the production of the activated carbon and the treatment conditions (heating temperature, time, and the like), the pulverization conditions, and the classification conditions.

As the activated carbon, a commercially available product may be used. Alternatively, for example, an activated carbon obtained by subjecting a carbonaceous material to be a raw material of the activated carbon to a carbonization treatment as necessary, and then subjecting the carbonaceous material to an activation treatment, and a washing treatment, a drying treatment, and a pulverization treatment as necessary may also be used.

Examples of the carbonaceous material to be a raw material include, without particular limitation, plant-based carbonaceous materials (e.g., plant-derived materials such as wood, wood shavings, charcoal, fruit shells, for example coconut shells and walnut shells, fruit seeds, pulp production by-products, lignin, and blackstrap molasses), mineral-based carbonaceous materials (e.g., mineral-based materials such as peat, lignite, brown coal, bituminous coal, anthracite, cokes, coal tar, coal pitch, petroleum distillation residues, and petroleum pitch), synthetic resin-based carbonaceous materials (e.g., materials derived from synthetic resins such as phenol resin, polyvinylidene chloride, and acrylic resin), and natural fiber-based carbonaceous materials (e.g., materials derived from natural fibers such as natural fibers, for example cellulose, and regenerated fibers, for example rayon). These carbonaceous materials may be used alone, or two or more thereof may be used in combination.

Of these carbonaceous materials, coconut shell or a phenol resin is preferable from the viewpoint that micropores involved in volatile organic compound removal performance defined in JIS S 3201: 2019 are likely to be developed.

When a carbonization treatment is required, the carbonaceous material may be usually subjected to a carbonization treatment at, for example, 400° C. to 800° C., preferably 500° C. to 800° C., more preferably about 550° C. to 750° C. in an environment in which oxygen or air is blocked. Thereafter, the particle size may be adjusted as necessary.

Thereafter, the carbonaceous material is subjected to an activation treatment. The activation treatment is a treatment for forming pores on the surface of the carbonaceous material to change the carbonaceous material into activated carbon which is a porous body. The activation treatment may be performed by a method common in the technical field, and the method is not particularly limited. For example, two types of treatment methods, a gas activation treatment and a chemical activation treatment, can be mainly mentioned. Of these, when the carbonaceous material is used for water purification treatment, a gas activation treatment is preferable from the viewpoint of less residual impurities.

The gas activation treatment is, for example, a treatment of heating the carbonaceous material in the presence of water vapor, carbon dioxide, air, oxygen, combustion gas, or a mixed gas thereof. The heating temperature is not particularly limited, but for example, the heating is performed at a temperature of about 700° C. to 1100° C., preferably 800° C. to 980° C., and more preferably 850° C. to 950° C. The activation time and the rate of temperature rise are not particularly limited and may be appropriately adjusted according to the type, shape, and size of the carbonaceous material to be selected. In consideration of safety and reactivity, it is preferable to use a water-vapor-containing gas containing water vapor in an amount of 10 vol % to 40 vol %. The chemical activation treatment may be performed, for example, by a known method of mixing an activator such as zinc chloride, calcium chloride, phosphoric acid, sulfuric acid, sodium hydroxide, potassium hydroxide, magnesium hydroxide, or calcium hydroxide with the carbonaceous material and heating the mixture under an inert gas atmosphere.

The activated carbon after the activation treatment is washed and dried as necessary. Specifically, when a plant-based carbonaceous material such as coconut shell or a mineral-based carbonaceous material containing impurities such as alkali metal, alkaline earth metal, and transition metal is used as a raw material of the activated carbon, washing is performed as necessary to remove ash, chemicals, and the like. A mineral acid or water is used for washing. The mineral acid is preferably hydrochloric acid having high washing efficiency.

The activated carbon after the activation treatment is subjected to a pulverization treatment and/or classification treatment as necessary. The pulverization treatment may be performed using a pulverizer typically used for pulverizing activated carbon, for example, a high-speed rotating mill such as an aerofall mill, a rod mill, a roller mill, a hammer mill, a blade mill, or a pin mill, a ball mill, a jet mill, or the like. Examples of the classification treatment include methods typically used for classification of activated carbon, for example, classification using a sieve, wet classification, dry classification, and the like. Examples of a wet classifier include classifiers using principles such as gravity classification, inertial classification, hydraulic classification, and centrifugal classification. Examples of a dry classifier include classifiers using principles such as sedimentation classification, mechanical classification, and centrifugal classification.

Through such a process, activated carbons in various shapes such as powdered activated carbon, particulate activated carbon, and fibrous activated carbon can be obtained.

### (Optional Component)

The water purification filter may further comprise other optional functional components as long as the effect of the adsorption performance in the first embodiment is not impaired. Examples of other optional components include lead adsorbents such as titanosilicate and zeolite-based powders, ion exchange resins, chelating resins, and various adsorbents containing silver ions and/or silver compounds for imparting antibacterial properties.

The blending amount of these other optional components is not particularly limited, but for example, these optional functional components may be blended in an amount of 0.1 parts by mass to 100 parts by mass in 100 parts by mass of the total of activated carbon and these optional functional components.

The water purification filter comprising activated carbon and one or more fibrous binders may further comprise a core, and the filter may be a cylindrical water purification filter. With the cylindrical shape, when the water purification filter is filled in a housing and used as a cartridge, loading and replacement work of the cartridge into the water purifier can be simplified.

The core is not particularly limited as long as it can be inserted into a hollow portion of the cylindrical water purification filter and can prevent leakage of activated carbon from the cylindrical water purification filter. Examples of the core include a trical pipe, a netron pipe, and a ceramic filter. Further, a nonwoven fabric or the like may be wound around the outer periphery of the core to be used. Alternatively, a nonwoven fabric may be formed into a cylindrical shape and used as a core.

### [Method for Producing Water Purification Filter]

The method for producing the water purification filter may be any method known to those skilled in the art, and the method is not particularly limited. From the viewpoint of efficient production, a slurry suction method is preferable.

Hereinafter, an example of a method for producing a cylindrical water purification filter will be described in detail, but the present invention is not limited to this production method.

Specifically, for example, the water purification filter (molded body) may be produced by a method including a slurry preparation step, a suction filtration step, a rolling step as necessary, a drying step, and a grinding step as necessary. In the slurry preparation step, activated carbon and a fibrous binder are dispersed in water, whereby a slurry is prepared. In the suction filtration step, the prepared slurry is filtered while being sucked, whereby a preform is obtained. In the rolling step, the shape of the outer surface of the preform is adjusted as necessary by compressing the preform after suction filtration on a shaping table. In the drying step, the shaped preform is dried to obtain a dried molded body. In the grinding step, the outer surface of the dried molded body is ground as necessary. Hereinafter, each step will be described in more detail.

### (Slurry Preparation Step)

In the slurry preparation step, a slurry in which activated carbon and the fibrous binder (and optional components) described above are dispersed in a solvent is prepared in such a manner that the amount of the fibrous binder is 2 parts by mass to 20 parts by mass with respect to 100 parts by mass of activated carbon or with respect to 100 parts by mass of a total of activated carbon and a functional component (for example, a lead adsorbent), and a solid content concentration is 0.1 mass % to 10 mass %, preferably 1 mass % to 5 mass % with respect to the total weight of the slurry, for example. The solvent is not particularly limited, and water or the like is preferably used. Adjusting the solid content concentration of the slurry to a concentration that is not too high can easily achieve uniform dispersion and can prevent the molded body from having unevenness. On the other hand, adjusting the solid content concentration of the slurry to a concentration that is not too low can shorten the molding time and can improve the productivity. Further, it is also possible to suppress the density of the molded body from becoming too high and to maintain good water permeability.

### (Suction Filtration Step)

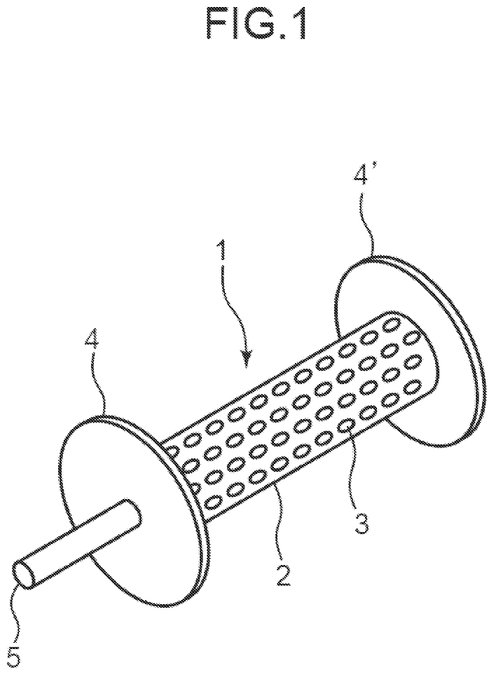

The suction filtration step will be described with reference to FIG. 1. In FIG. 1, reference numerals denote a framework 1, a core body 2, a suction hole 3, flanges 4 and 4′, and a filtrate discharge port 5. In the suction filtration step, for example, the framework 1 for a cylindrical molded body as illustrated in FIG. 1 is used. The framework 1 has a large number of suction holes 3 on the surface of the core body 2, is attached with flanges 4 and 4′ at both ends thereof, and is provided with the filtrate discharge port 5. First, a core as described above is attached to the framework 1, the prepared slurry is put in the framework 1 and filtered while being sucked from the inside of the framework 1 from the filtrate discharge port 5, whereby the slurry is attached to the framework 1. As the suction method, a conventional method, for example, a method of sucking using a suction pump or the like may be used. The preform is thus attached to the framework 1.

### (Rolling Step)

As necessary, after the suction filtration step, a rolling step may also be performed to adjust the outer diameter of the preform to a predetermined size, to increase the roundness, and to reduce the unevenness of the outer peripheral surface. In the rolling step, the framework 1 to which the preform obtained in the suction filtration step is attached may be placed on a table and moved back and forth while being pressed with a predetermined force.

The suction filtration step and the rolling step performed as necessary may be performed any number of times.

### (Drying Step)

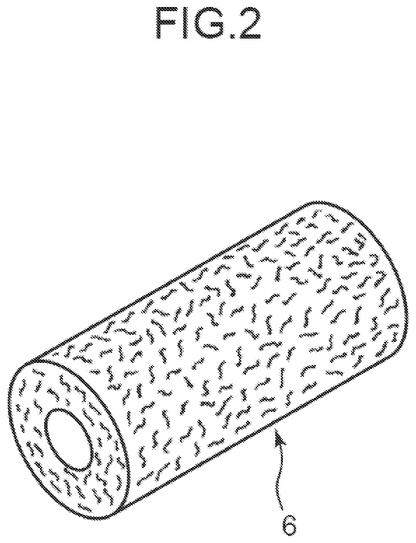

Next, the flanges 4 and 4′ at both ends of the framework 1 are removed, and the core body 2 is removed. A hollow cylindrical preform can be thus obtained. In the drying step, the preform thus removed from the framework 1 is dried with a dryer or the like, whereby a molded body 6 (water purification filter in the first embodiment) illustrated in FIG. 2 can be obtained.

The drying temperature is, for example, about 100° C. to 150° C., particularly about 110° C. to 130° C. The drying time is, for example, about 4 to 48 hours, particularly about 8 to 16 hours. By setting the drying temperature to a temperature that is not too high, it is possible to make it difficult to cause deterioration in filtration performance or deterioration in strength of the molded body due to alteration or melting of the fibrous binder. By setting the drying temperature to a temperature that is not too low, the drying time can be shortened, and insufficient drying can be prevented.

### (Grinding Step)

As necessary, after the drying step, a grinding step may be performed to further adjust the outer diameter of the water purification filter or to reduce unevenness of the outer peripheral surface. The grinding method is not particularly limited as long as the outer surface of the dried molded body can be ground (or polished), and any grinding method known to those skilled in the art may be used. From the viewpoint of the uniformity of grinding, a method using a grinding machine that rotates and grinds the molded body itself is preferable.

A specific method of the grinding step is not limited to a method using a grinding machine, and for example, the molded body fixed to a rotating shaft may be ground with a fixed flat grindstone. In this method, since the generated grinding dregs are easily deposited on the grinding surface, it is effective to perform grinding while blowing air.

The water purification filter can be produced, for example, by the production method described above, molded, dried, and then cut into a desired size and shape for use. Further, a cap may be attached to a tip portion or a nonwoven fabric may be attached to the surface as necessary.

### 1-2. Second Embodiment

A water purification filter according to a second embodiment comprises activated carbon and one or more fibrous binders, wherein a lightness L* of a surface of the activated carbon layer of the water purification filter is 29 or more.

The water purification filter having such a physical property has excellent adsorption performance. Specifically, the high lightness L* of the surface of the activated carbon layer of the water purification filter means that the light reflectance of the surface of the activated carbon layer of the water purification filter is high and the light scattering ability of the surface of the activated carbon layer of the water purification filter is also high. Thus, when the lightness L* of the surface of the activated carbon layer of the water purification filter is 29 or more, it is assumed that the water purification filter has a high density. That is, in such a water purification filter, it is assumed that the frequency of contact between water and activated carbon as an adsorbent is improved, and the adsorption performance can be finally improved.

The lightness L* of the surface of the activated carbon layer of the water purification filter is preferably 31 or more, more preferably 33 or more, and still more preferably 35 or more. The upper limit of the lightness L* of the surface of the activated carbon layer of the water purification filter is not particularly limited, but it may be, for example, 45 or less from the viewpoint of water permeability.

In the present specification, the “lightness L* of the surface of the activated carbon layer of the water purification filter” is a value measured using a spectrophotometric colorimeter in accordance with the condition c of JIS Z 8722: 2009 as described in detail later in Examples.

As described above, when the density of the water purification filter is high, it is assumed that the lightness L* of the surface of the activated carbon layer of the water purification filter has a high value of 29 or more. In other words, it is assumed that the water purification filter of the second embodiment having a lightness L* of 29 or more can be obtained by using the fibrous binder having predetermined physical properties in the first embodiment described above (that is, a fibrous binder having a maximum fiber length of 3.0 mm or more and having one or more of the properties (a) to (c)) as the fibrous binder comprised in the water purification filter.

Further, by using a fibrous binder in which one or more of the maximum fiber length, the average shape, the average fiber width, and the fiber length ratio (0.2 mm to 0.5 mm)/(1.0 mm to 2.0 mm) have the preferable values in the first embodiment described above as the fibrous binder comprised in the water purification filter, it is assumed that the lightness L* can be set to a higher value. That is, it is assumed that the water purification filter can be reliably densified, and as a result, the adsorption performance of the water purification filter can be reliably improved.

In the second embodiment, as in the first embodiment described above, by using, as the fibrous binder comprised in the water purification filter, a fibrous binder having not only a maximum fiber length of 3.0 mm or more and one or more of the physical properties (a) to (c) but also the physical property (d) of having an average fibril area of 11% or more, the trapping performance of the activated carbon of the water purification filter and the strength of the water purification filter can be further improved. That is, it is assumed that the water purification filter can be more reliably densified, and as a result, the adsorption performance of the water purification filter can be more reliably improved.

In addition, as in the first embodiment described above, it is assumed that the lightness L* can be more reliably set to a high value by using a fibrous binder having, preferably, all the physical properties (a) to (c) as the fibrous binder comprised in the water purification filter. That is, it is assumed that the water purification filter can be more reliably densified, and as a result, the adsorption performance of the water purification filter can be more reliably improved. In addition, it is assumed that the strength of the resulting water purification filter can be improved by using a fibrous binder having, more preferably, all the physical properties (a) to (d) as the fibrous binder comprised in the water purification filter.

Other details such as specific examples of the fibrous binder comprised in the water purification filter, activated carbon, optional components, and blending ratios thereof in the second embodiment are the same as those in the first embodiment. The method for producing the water purification filter is also the same as those in the first embodiment.

### 2. Water Purification Cartridge and Water Purifier

The water purification filter in the first or second embodiment described above can be used as a water purification cartridge by being filled in a housing. The water purification cartridge is loaded in a water purifier and supplied for water passing. In this case, as the water passing method, a total filtration method or a circulation filtration method of filtering the entire amount of raw water can be adopted. The water purification cartridge loaded in the water purifier may be used by, for example, filling the water purification filter in a housing. Alternatively, the water purification filter can be used in further combination with a known nonwoven fabric filter, various adsorbents, a mineral additive, a ceramic filter material, and the like.

Although the outline of the present invention has been described above, the water purification filter and the water purifier according to the present embodiments are summarized as follows.

A water purification filter according to a first aspect of the present invention comprises activated carbon and one or more fibrous binders, wherein the fibrous binder has a maximum fiber length of 3.0 mm or more and has one or more physical properties (a) to (c) shown below:
(a) having an average shape of 80% or less;
(b) having an average fiber width of 20 μm or less; and
(c) in a fiber length distribution, having a ratio of a frequency of fibers having a length of 0.2 mm to 0.5 mm to a frequency of fibers having a length of 1.0 mm to 2.0 mm of 1.0 or more.

Alternatively, a water purification filter according to another first aspect of the present invention comprises activated carbon and one or more fibrous binders, wherein a lightness L* of a surface of an activated carbon layer of the water purification filter is 29 or more.

In the water purification filter, the fibrous binder preferably has a physical property (d) having an average fibril area of 11% or more.

In the water purification filter, the activated carbon more preferably has a D50 measured by a laser diffraction/scattering method of 13 μm or more and 500 μm or less.

In the water purification filter, the activated carbon further preferably has a specific surface area determined by a nitrogen adsorption method of 800 m²/g or more and 2200 m²/g or less.

In the water purification filter, the activated carbon particularly preferably has a total pore volume determined by a nitrogen adsorption method of 0.350 cm³/g or more and 1.600 cm³/g or less.

In the water purification filter, the activated carbon is preferably powdered activated carbon.

In the water purification filter, the water purification filter more preferably has a cylindrical shape.

A water purifier according to a second aspect of the present invention comprises the water purification filter according to the first aspect of the present invention.

### EXAMPLES

Hereinafter, the present invention will be described more specifically with reference to Examples, but the present invention is not limited by Examples at all.

In Examples, a water purification filter comprising activated carbon and a fibrous binder was actually produced, and the performance of the water purification filter was evaluated.

First, a method for measuring physical properties of a fibrous binder and activated carbon, and fibrous binders, activated carbon, and other raw materials used in Examples and Comparative Examples will be described in detail.

### [Measurement of Average Fiber Length, Average Shape, Average Fiber Width, Average Fibril Area, and Fiber Length Distribution of Fibrous Binder]

The physical properties of each fibrous binder used as a raw material or a mixture of two fibrous binders at specific blending proportions were measured by the following method. First, a fibrous binder or a mixture of two fibrous binders at specific blending proportions, in a wet state, was placed in a 500 mL volume glass beaker, and 200 mL of ion-exchanged water was further added in the beaker. The contents were well stirred and suspended to obtain a 0.05 wt % binder suspension. The 500 mL volume beaker containing the 0.05 wt % binder suspension was placed in a fiber physical property measurement apparatus (“L&W FIBER TESTER PLUS+”, manufactured by ABB Ltd.), and the apparatus was operated. Each physical property of the fibers was measured by image analysis of 20,000 fibers having a fiber length of 200 μm or more under the condition of a water temperature of 20° C. Specifically, based on the measured values of the fiber length, shape, fiber width, and fibril area of 20,000 fibers having a fiber length of 200 μm or more obtained by image analysis, the average fiber length (length-weighted average fiber length), average shape (length-weighted average shape), average fiber width (length-weighted average fiber width), and average fibril area (length-weighted average fibril area) of each fibrous binder were determined from the following length-weighted average formula (1) according to the provision of JIS P 8226-2: 2011 (ISO 16065-2). Further, data of the fiber length distribution (length-weighted fiber length distribution) of each fibrous binder was also obtained from the fiber lengths of 20,000 fibers according to Formula (2).

$$\begin{matrix}[ Mathematical Formula 1 ] & \\ Length - weighted average of X = \frac{{\sum }_{i = 1}^{n} ( {x}_{i} {l}_{i} )}{{\sum }_{i = 1}^{n} {l}_{i}} & Formula ( 1 )\end{matrix}$$

(In Formula (1), X represents any of a fiber length, a shape, a fiber width, and a fibril area, x represents a measured value of X, l represents a fiber length, i represents a data number, and n represents a total number of data.)

$$\begin{matrix}[ Mathematical Formula 2 ] & \\ Frequency [ \% ] = \frac{{n}_{j} {l}_{j}}{{\sum }_{j = 1}^{m} {n}_{j} {l}_{j}} \times 100 & Formula ( 2 )\end{matrix}$$

(In Formula (2), n represents the number of fibers included in a class, l represents an arithmetic average fiber length of the class, j represents a class number, and m represents the number of classes.)

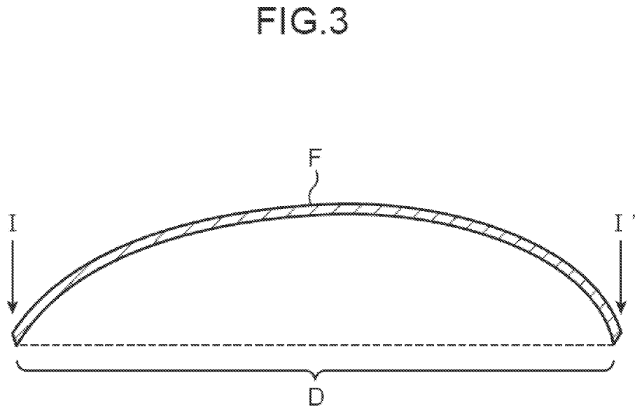

Here, FIG. 3 illustrates a schematic view for describing a method for calculating the shape (%) of a fiber of the fibrous binder. Referring to FIG. 3, the value (%) of the shape of each fiber can be obtained by the following Formula (3).

$$Shape ( \% ) = [ \text{} ( distance D between end point I and end point {I}^{′} of fiber F ) / ( fiber length ( length of fiber F ) ) ] \times 100 \qquad Formula ( 3 )$$

The fibril area of each fiber is a value obtained from the following Formula (4).

$$Fibril area ( \% ) = [ \text{} ( area of fibrillated portion ) / ( area of fibrillated portion + fiber stem area ) ] \times 100 \qquad Formula ( 4 )$$

### [Measurement of 50% Particle Size (D50) of Activated Carbon]

The 50% particle size (D50) in the volume-based cumulative particle size distribution of the raw material activated carbon was measured by a laser diffraction/scattering method. That is, activated carbon to be measured was placed in ion-exchanged water together with a surfactant and subjected to ultrasonic vibration to produce a uniform dispersion liquid, and measurement was performed using a wet particle size distribution measuring apparatus (“Microtrac MT 3300 EX-II” manufactured by MicrotracBEL Corp.). As the surfactant, “polyoxyethylene (10) octylphenyl ether” manufactured by FUJIFILM Wako Pure Chemical Corporation was used. The analysis conditions are shown below.

### (Analysis Conditions)

Number of measurements; average value of three times
Measurement time; 30 seconds
Distribution display; volume
Particle size classification; standard
Calculation mode; MT3000II
Solvent name; WATER
Measurement upper limit; 2000 μm, measurement lower limit; 0.021 μm
Residual ratio; 0.00
Passed fraction ratio; 0.00
Residual ratio setting; invalid
Particle permeability; absorption
Particle refractive index; N/A
Particle shape; N/A
Solvent refractive index; 1.333
DV value; 0.0882
Transmittance (TR); 0.880 to 0.900
Extension filter; invalid
Flow rate; 70%
Ultrasonic output; 40 W
Ultrasonic time; 180 seconds

### [Measurement of Specific Surface Area of Activated Carbon]

The specific surface area of activated carbon was measured by the following method. The activated carbon to be measured was heated at 300° C. for 3 hours under a nitrogen stream (nitrogen flow rate: 50 mL/min) and then a nitrogen adsorption/desorption isotherm of the activated carbon at 77 K was measured, using a gas adsorption measuring apparatus (“BELSORP-mini” manufactured by MicrotracBEL Corp.). The obtained nitrogen adsorption isotherm was analyzed by a multipoint method using the BET equation, and the specific surface area (m²/g) was calculated from the straight line in the region of the relative pressure P/P0=0.01 to 0.1 of the obtained curve.

### [Measurement of Total Pore Volume of Activated Carbon]

The total pore volume of activated carbon was measured by the following method. The activated carbon to be measured was heated at 300° C. for 3 hours under a nitrogen stream (nitrogen flow rate: 50 mL/min) and then a nitrogen adsorption/desorption isotherm of the activated carbon at 77 K was measured, using a gas adsorption measuring apparatus (“BELSORP-mini” manufactured by MicrotracBEL Corp.). The nitrogen adsorption amount at a relative pressure P/P0=0.990 of the obtained nitrogen adsorption isotherm was converted into the volume of liquid nitrogen by the following Formula (5), and the obtained value of the volume was taken as the total pore volume (cm³/g).

$$Total pore volume ( {cm}^{3} / g ) = ( nitrogen adsorption amount \times molecular weight of nitrogen ) \text{} / ( 22414 \times density of nitrogen ) \qquad Formula ( 5 )$$

### [Raw Material]

### (Fibrous Binder)

As the raw material fibrous binders, the following fibrous binders were used. The cellulose fibrous binder is not a raw material but a fibrous binder used as a reference for physical property comparison.
Acrylic fibrous binder A: a binder obtained by suspending “CFF111” manufactured by Sterling Fibers Inc. in tap water and refining the same. CSF value 21 mL to 42 mL
Acrylic fibrous binder B: “CFF111” manufactured by Sterling Fibers Inc., CSF value 200 mL to 250 mL
Acrylic fibrous binder C: “Bi-PUL/F” manufactured by Japan Exlan Co., Ltd., CSF value 92 mL to 120 mL
Cellulose fibrous binder: “CELISH” manufactured by Daicel Miraizu Ltd., CSF value 30 mL or less

Further, the physical properties of each fibrous binder and a mixture of two fibrous binders at specific blending proportions measured by the method described above are shown in Table 1 below.

TABLE 1

| | Physical properties (length- | | | |
|---|---|---|---|---|
| | weighted average) of fibrous binder | | | |
| | Average | | Average | Average |
| | fiber | Average | fiber | fibril |
| | length | shape | width | area |
| | (mm) | (%) | (μm) | (%) |
| Acrylic fibrous binder A | 0.517 | 77.8 | 17.6 | 16.2 |
| Acrylic fibrous binder B | 1.355 | 77.9 | 19.0 | 9.4 |
| Acrylic fibrous binder B 73% + | 1.247 | 79.16 | 19.86 | 10.1 |
| acrylic fibrous binder C 27% | | | | |
| Acrylic fibrous binder C | 1.004 | 82.2 | 21.7 | 11.9 |
| Cellulose fibrous binder | 0.492 | 85.2 | 22.1 | 12.7 |

Further, the fiber length distribution of each fibrous binder and the mixture of two fibrous binders at specific blending proportions measured by the method described above are shown in Table 2 below.

TABLE 2

| | Frequency (%) | | | | |
|---|---|---|---|---|---|
| | | | Acrylic fibrous | | |
| Fiber | Acrylic | Acrylic | binder B 73% + | Acrylic | Cellulose |
| length | fibrous | fibrous | acrylic fibrous | fibrous | fibrous |
| (μm) | binder A | binder B | binder C 27% | binder C | binder |
| 200-500 | 82.44 | 38.39 | 34.32 | 33.16 | 63.45 |
| 500-1000 | 15.07 | 24.51 | 22.67 | 23.11 | 31.73 |
| 1000-2000 | 2.35 | 20.84 | 27.32 | 41.01 | 4.66 |
| 2000-3000 | 0.09 | 9.08 | 7.83 | 2.16 | 0.17 |
| 3000-4000 | 0.04 | 5.08 | 4.32 | 0.51 | 0.00 |
| 4000-5000 | 0.01 | 2.09 | 1.70 | 0.03 | 0.00 |
| 5000-7500 | 0.00 | 2.70 | 1.28 | 0.00 | 0.00 |
| 7500 or more | 0.01 | 0.57 | 0.55 | 0.00 | 0.00 |

From Tables 1 and 2, it is found that the acrylic fibrous binder A has all the physical property conditions (a) having an average shape of 80% or less; (b) having an average fiber width of 20 μm or less; (c) having a fiber length ratio (0.2 mm to 0.5 mm)/(1.0 mm to 2.0 mm) of 1.0 or more; and (d) having an average fibril area of 11% or more. It is found that the acrylic fibrous binder B and the mixture of 73% of the acrylic fibrous binder B and 27% of the acrylic fibrous binder C satisfy the physical property conditions (a) to (c). It is found that the acrylic fibrous binder C satisfies only the physical property condition (d). From Table 2, it is found that the binders other than the cellulose fibrous binder or the mixture of two binders satisfy the physical property condition of a maximum fiber length of 3.0 mm or more.

### (Activated Carbon)

A method for producing activated carbon used as a raw material, specifically powdered activated carbon, is described, but the production method is not particularly limited as long as the required physical properties are satisfied.

### Activated Carbon a (Powdered Activated Carbon)

Coconut shell coal obtained by carbonizing coconut shell made in Philippines was activated by water vapor at 900° C. to 950° C., the activation time was adjusted so that a target benzene adsorption amount was obtained, and the obtained coconut shell activated carbon was washed with dilute hydrochloric acid and desalted with ion-exchanged water to obtain granular activated carbon (JIS K 1474: 2014, 18×42 mesh, benzene adsorption amount 30.4 wt %). The obtained granular activated carbon was pulverized with a rod mill such that D50 was 96.7 μm to obtain activated carbon A (powdered activated carbon).

Physical properties of the activated carbon A measured by the method described above are summarized in Table 3 below.

TABLE 3

| | Physical properties of activated carbon | | | |
|---|---|---|---|---|
| | Benzene | | Specific | Total |
| | adsorption | | surface | pore |
| | amount | D50 | area | volume |
| | (wt %) | (μm) | (m²/g) | (cm³/g) |
| Activated carbon A | 30.4 | 96.70 | 975 | 0.423 |

### (Others)

In addition, the following core and nonwoven fabric were used.
Core: a core produced by processing a nonwoven fabric (“9540F” manufactured by SHINWA Co., Ltd.) into a cylindrical shape
Nonwoven fabric: “9540F” manufactured by SHINWA Co., Ltd.

Next, a method for measuring physical properties and a method for evaluating performance of the produced water purification filter will be described in detail.

### Measurement of L*a*b* Color Space on Surface of Activated Carbon Layer of Water Purification Filter

The L*a*b* color space on the surface of the activated carbon layer of the water purification filter was measured in accordance with the condition c of JIS Z 8722: 2009. Specifically, first, a powder cover set (“CM-A149”, manufactured by KONICA MINOLTA, INC.) was attached to a portable spectrophotometric colorimeter (“CM-2600d”, manufactured by KONICA MINOLTA, INC.). Thereafter, the flat bottom surface of the activated carbon layer of the cylindrical water purification filter was pressed against the measurement unit of the spectrophotometric colorimeter so that light does not enter from the outside, and the L*a*b* color space of the surface was measured. Here, when the water purification filter was cut and the L*a*b* color space of the activated carbon layer at the cut surface of the water purification filter was measured, the measurement was performed using a sample left for 1 week or more after the cutting to stabilize the L*a*b* color space at the cut surface. Note that, L* represents lightness, and a* and b* represent chromaticity. The measurement conditions were as follows.

### (Measurement Conditions)

Number of measurements; average value of three times
Light source: D65
Field of view: 10°
Measurement method: SCI

### [Measurement of Water Purification Filter Weight]

The filter weight (g) was determined by measuring the weight after drying the molded cylindrical water purification filter at 120° C. for 2 hours with an electronic balance.

### [Measurement of Chloroform Filtration Capacity]

The chloroform filtration capacity was measured in accordance with JIS S 3201: 2019. Specifically, raw water having a chloroform concentration of 60+12 ppb and having a temperature of 20° C. was allowed to flow from the outside to the inside of the cylindrical water purification filter at a flow rate of 1.1 L/min. The integrated water passing amount (L) at the time when the removal rate of chloroform was less than 80% was measured and evaluated as the chloroform filtration capacity.

### [Measurement of Turbidity Filtration Capacity]

The turbidity filtration capacity was measured in accordance with JIS S 3201: 2019. Raw water at 20° C. having a turbidity of 2.0+0.2 degrees of kaolin for turbidity test was allowed to flow from the outside to the inside of the cylindrical water purification filter at a dynamic water pressure of 0.1 MPa and at a flow rate of 1.1 L/min, and the removal rate after 10 minutes from the start of water passing was measured as an initial turbidity removal rate (%). Further, the turbidity removal rate (%) and the filtration flow rate (L/min) at the time when the integrated water passing amount reached 1200 L were also measured.

### [Measurement of Initial Waterflow Resistance]

Test water at 20° C. was allowed to flow at a flow rate of 1.1 L/min from the outside to the inside of the water purification filter, and the waterflow resistance (MPa) after 10 minutes from the start of water flow was measured.

### [Measurement of Compressive Strength]

The cylindrical water purification filter was disposed in a Tensilon universal material testing machine (“RTC-1210A” manufactured by A&D Company, Limited), and the compressive strength was measured. The measurement conditions are as follows.

### (Measurement Conditions)

Compression plate distance; 30 mm
Sample height; 10 mm
Elongation origin; Initial load
Initial load value; 0.3 N
Regression point calculation direction; Load
Load at calculation start point; 0.1 N
Load at calculation end point; 50 N
Calculation pitch load; 0.1 N

Next, a method for producing a water purification filter in each of Examples and Comparative Examples, and physical properties and performance evaluation results of the produced water purification filter will be described in detail.

### Example 1

The activated carbon A and the acrylic fibrous binder A were prepared so as to be 1.055 kg in total at the blending ratio shown in Table 4 below, and tap water was added. The amount of slurry after addition was 10.55 L.

Next, a core made of a nonwoven fabric (“9540F” manufactured by SHINWA Co., Ltd.) was attached to the framework for cylindrical molding (outer diameter: 35 mmϕ, center shaft diameter: 9.9 mmϕ, outer diameter flange interval: 230 mmH) illustrated in FIG. 1 described above, and a mold was produced. The obtained slurry was sucked at 300 mmHg to be molded to 36 mmϕ slightly larger than the outer diameter of the mold, and then dried. Next, the obtained molded body was mounted on an automatic grinding machine, and the outer surface of the molded body was ground. Thereafter, both ends of the molded body were cut to obtain a cylindrical water purification filter having an outer diameter of 34.82 mmϕ, an inner diameter of 10.00 mmϕ, and a height of 71.5 mmH.

The weight, compressive strength, and L*a*b* color space of the water purification filter thus obtained were measured by the method described above. The results are summarized in Table 5 below.

Thereafter, with a hot melt adhesive, a disk-shaped packing made of an ABS resin having an outer diameter of about 96.5 mm was bonded to one end of the water purification filter, and a disk-shaped packing made of an ABS resin having an outer diameter of about 96.5 mm and a water outflow diameter of about 6.8 mm at the center was bonded to the other end.

The water purification filter to which the packings were bonded was loaded in a stainless steel housing having an average diameter of 98 mm, a length of about 240 mm, and an intrinsic amount of about 1809 cm³. Using this, water was allowed to pass from the outside to the inside, and the chloroform filtration capacity, the turbidity removal capacity, and the initial waterflow resistance were measured by the methods described above. These measurement results are also summarized in Table 5 below.

### Example 2

As shown in Table 4 below, in Example 2, a cylindrical water purification filter was obtained in the same manner as in Example 1 except that the acrylic fibrous binder B was blended instead of the acrylic fibrous binder A in the raw material. Physical property measurement results and performance measurement results of the water purification filter in Example 2 are also summarized in Table 5 below.

### Example 3

As shown in Table 4 below, in Example 3, a cylindrical water purification filter was obtained in the same manner as in Example 1 except that 4 parts by mass of the acrylic fibrous binder B and 1.5 parts by mass of the acrylic fibrous binder C were blended instead of the acrylic fibrous binder A in the raw material. Physical property measurement results and performance measurement results of the water purification filter in Example 3 are also summarized in Table 5 below.

### Comparative Example 1

As shown in Table 4 below, in Comparative Example 1, a cylindrical water purification filter was obtained in the same manner as in Example 1 except that the acrylic fibrous binder C was blended instead of the acrylic fibrous binder A in the raw material. Physical property measurement results and performance measurement results of the water purification filter in Comparative Example 1 are also summarized in Table 5 below.

TABLE 4

| | Blending ratio | | | |
|---|---|---|---|---|
| | | Acrylic | Acrylic | Acrylic |
| | Activated | fibrous | fibrous | fibrous |
| | carbon A | binder A | binder B | binder C |
| | (parts | (parts | (parts | (parts |
| | by mass) | by mass) | by mass) | by mass) |
| Example 1 | 100 | 5.5 | — | — |
| Example 2 | 100 | — | 5.5 | — |
| Example 3 | 100 | — | 4 | 1.5 |
| Comparative | 100 | — | — | 5.5 |
| Example 1 | | | | |

In Table 4, “—” means not being contained.

TABLE 5

| | | | | | Performance of water purification filter | | | | | |
|---|---|---|---|---|---|---|---|---|---|---|
| | Physical properties of water purification filter | | | | Chloroform | Turbidity filtration | | | | |
| | | | | Water | filtration | | | At filtration | Initial | |
| | | | | purification | (removal rate | Removal rate of turbidity | | flow amount | waterflow | Compression |
| | L*a*b* color space | | | filter weight | less than 80%) | Initial | At 1200 L | of 1200 L | resistance | strength |
| | L* | a* | b* | (g) | (L) | (%) | (%) | (L/min) | (MPa) | (N) |
| Example 1 | 35.11 | 0.05 | −0.43 | 25.72 | 1170 | 83 | 46 | 1.03 | 0.021 | 192.64 |
| Example 2 | 33.41 | 0.18 | −0.21 | 25.29 | 1160 | 65 | 28 | 1.00 | 0.015 | 63.84 |
| Example 3 | 31.27 | 0.19 | 0.04 | 25.40 | 1140 | 69 | 37 | 1.02 | 0.013 | 106.06 |
| Comparative | 26.75 | 0.14 | 0.8 | 24.90 | 1060 | 44 | 31 | 1.03 | 0.015 | 230.14 |
| Example 1 | | | | | | | | | | |

### [Consideration]

As shown in Table 5, the water purification filters of Examples 1 to 3 each had a heavier weight as compared with the water purification filter of Comparative Example 1, and had excellent overall adsorption performance in chloroform filtration and turbidity filtration. This is considered to be because in Examples 1 to 3, the shape of the fibers of the fibrous binder was deformed, the activated carbon and the fibers were well entangled between the fibers, the filling property at the time of molding was improved, and the water purification filter was densified. In particular, as compared with the water purification filter of Comparative Example 1, the water purification filter of Example 1 using the acrylic fibrous binder A satisfying all the physical property conditions (a) to (d) had remarkably excellent adsorption performance and was able to maintain a sufficiently high value of compressive strength.

In addition, as shown in Table 5, in the water purification filters of Examples 1 to 3, which are densified and considered to have excellent adsorption performance, the lightness L* of the surface of the activated carbon layer of each water purification filter was 29 or more.

This application is based on Japanese Patent Application No. 2021-125623 filed on Jul. 30, 2021, the contents of which are included in the present application.

Although the present invention has been appropriately and fully described above through embodiments and Examples with reference to specific examples and the like to express the present invention, it should be recognized that those skilled in the art can easily modify and/or improve the foregoing embodiments and Examples. Therefore, unless a change or improvement made by those skilled in the art is at a level departing from the scope of rights of the claims described in the claims, the change or improvement is interpreted to be included in the scope of rights of the claims.

### INDUSTRIAL APPLICABILITY

The water purification filter of the present invention, having excellent adsorption performance, can exhibit good adsorptivity, for example, even when the water purification filter is downsized.

1. A water purification filter comprising activated carbon and one or more fibrous binders,
wherein the fibrous binder has a maximum fiber length of 3.0 mm or more and has one or more physical properties (a) to (c) shown below:
(a) having an average shape of 80% or less;
(b) having an average fiber width of 20 μm or less; and
(c) in a fiber length distribution, having a ratio of a frequency of fibers having a length of 0.2 mm to 0.5 mm to a frequency of fibers having a length of 1.0 mm to 2.0 mm of 1.0 or more.

2. A water purification filter comprising activated carbon and one or more fibrous binders,
wherein a lightness L* of a surface of an activated carbon layer of the water purification filter is 29 or more.

3. The water purification filter according to claim 1, wherein the fibrous binder has a physical property (d) having an average fibril area of 11% or more.

4. The water purification filter according to claim 1, wherein the activated carbon has a D50 measured by a laser diffraction/scattering method of 13 μm or more and 500 μm or less.

5. The water purification filter according to claim 1, wherein the activated carbon has a specific surface area determined by a nitrogen adsorption method of 800 m²/g or more and 2200 m²/g or less.

6. The water purification filter according to claim 1, wherein the activated carbon has a total pore volume determined by a nitrogen adsorption method of 0.350 cm³/g or more and 1.600 cm³/g or less.

7. The water purification filter according to claim 1, wherein the activated carbon is powdered activated carbon.

8. The water purification filter according to claim 1, wherein the water purification filter has a cylindrical shape.

9. The water purification filter according to claim 1, wherein an acrylic fibrous binder is contained as the fibrous binder.

10. A water purifier comprising the water purification filter according to claim 1.

11. The water purification filter according to claim 2, wherein the fibrous binder has a physical property (d) having an average fibril area of 11% or more.

12. The water purification filter according to claim 2, wherein the activated carbon has a D50 measured by a laser diffraction/scattering method of 13 μm or more and 500 μm or less.

13. The water purification filter according to claim 2, wherein the activated carbon has a specific surface area determined by a nitrogen adsorption method of 800 m²/g or more and 2200 m²/g or less.

14. The water purification filter according to claim 2, wherein the activated carbon has a total pore volume determined by a nitrogen adsorption method of 0.350 cm³/g or more and 1.600 cm³/g or less.

15. The water purification filter according to claim 2, wherein the activated carbon is powdered activated carbon.

16. The water purification filter according to claim 2, wherein the water purification filter has a cylindrical shape.

17. The water purification filter according to claim 2, wherein an acrylic fibrous binder is contained as the fibrous binder.

18. A water purifier comprising the water purification filter according to claim 2.
